(19) United States
(12) Patent Application Publication
(10) Pub. No.: US 2024/0253318 A1
(43) Pub. Date: Aug. 1, 2024

(54) A PROCESS OF MANUFACTURING ENVELOPE INTEGRATED TIRE

(71) Applicants: SAMEER PANDA, Faridabad (IN); SMITIPARNA SATPATHY, Faridabad (IN); TUSHAR SAHU, Faridabad (IN)

(72) Inventors: SAMEER PANDA, Faridabad (IN); SMITIPARNA SATPATHY, Faridabad (IN); TUSHAR SAHU, Faridabad (IN)

(21) Appl. No.: 18/566,109

(22) PCT Filed: Jun. 1, 2022
(86) PCT No.: PCT/IB2022/055122

§ 371 Date: Dec. 1, 2023

(30) Foreign Application Priority Data
Jun. 1, 2021 (IN) 202111024456

(51) Int. Cl. B29D 30/06; B29D 30/08

(52) U.S. Cl. CPC B29D 30/0685; B29D 2030/0687; B29D 30/08

(57) ABSTRACT

The present invention provides a process of manufacturing envelope integrated tire comprising steps of: (a) placing a tread, at least one carcass ply, at least one inner liner having an inner surface and an outer surface; (b) joining a semi-vulcanized envelope between a surface of carcass ply and said inner surface of inner liner; (c) joining said surface of carcass ply and the tread of the envelope integrated tire; (d) joining a strengthening fabric on a side wall of said envelope integrated tire; (e) wrapping a bead to connect the envelope integrated tire to a rim of a wheel; (f) pasting through adhesive, curing and vulcanizing said carcass ply, inner liner and semi-vulcanized envelope on the tread to form an envelope integrated tire; (g) injecting a fluid inside said envelope through at least one injection valve; (h) fixing said injection valve to avoid any kind of leakage.

### FIELD OF THE INVENTION

The present invention relates to a manufacturing process of envelope integrated pneumatic tire to improve its strength, durability and life. More specifically, the present invention provides a manufacturing process for accommodating an envelope to carry/occupy a sealant and/or coolant that leads to increase in potency and verve of the tire.

### BACKGROUND OF THE INVENTION

Tire manufacturing process is a long process which includes a number of critical operations like tire building, tire painting and curing. Basic steps in tire manufacturing process include chemical mixing, calendaring, extruding, making beads, tire building and curing process. The first step of tire manufacturing is to mix the raw materials such as natural rubber, carbon filler and chemicals to form a mixture. The mixture has to undergo several processing operations to make it suitable for tire building. Calendaring is used to make inner layer/inner liner and rubber coating of fabric of the tire. After calendaring, the tire is sent to the green tire building machine. The operator of the tire building machine winds each ply on the drum of machine and a green tire is constructed. The constructed green tire comes to the painting stage wherein, the green tire is painted from both outside and inside of the green tire. After painting, the tire is cured through tire curing process in which the green tire is put over the bladder which is attached in the middle of the tire mould. Mould is fixed to the curing press heated platen. Steam is used to heat up the curing press platen. The bladder pushes the green tire into the mould. Due to heated mould and bladder inside the steam heat, the green tire starts to vulcanize which takes 12 to 60 minutes to cure the tire depending on size of the tire and compound used in rubber mixing. Hence, the conventional process of manufacturing the tire actively involves manual operation and is a time taking process and the usual yield using this process is only 4-5 tires per day.

KR100850694B1 discloses a pneumatic tire manufacturing method. The pneumatic tire manufacturing method includes a process of manufacturing a green tire by assembling non-vulcanized rubber elements, a process of vulcanizing the green tire, and winding a non-vulcanized rubber tape so that the windings are collectively unvulcanized rubber elements. Forming a predetermined cross-sectional shape for at least one of the elements to form the at least one unvulcanized rubber element. The drawback of the invention is that the given process is a time consuming process and according to the given process the yield of tires per day on an average is low.

DE60308532T2 discloses a method for manufacturing a tire, said tire structural elements such as a carcass, a bead core, a belt and a tread for molding a green tire to a hard ring core around are provided and the green tire together with the hard core into a mold is brought in and is vulcanized to obtain a pneumatic tire and to an apparatus for manufacturing a green tire applicable to the method of manufacturing a tire. There are two types of methods of forming a pneumatic tire: one in which a molded in a tire forming drum green tire is inserted into a mold, is inflated by means of a bladder, and vulcanizing the green tire, and another, in which a green tire on an external surface a metallic hard core which is formed in an annular shape is formed, the green tire is used together with the hard core into a mold and vulcanizing the green tire (a “core manufacturing method”). The main drawback of the invention is that the vulcanization is done in multiple steps.

EP1065042B1 discloses a method of manufacturing sealant-containing tires, wherein a green tire in which a tire body and an inner liner are laminated on each other and subjected to vulcanization molding with a bladder expanded by an air pressure from the inside thereof, a mold releasing sheet such as a fluororesin sheet having mold releasing property on one surface only thereof being inserted between the inner liner and tire body with the mold releasing property-carrying surface thereof opposed to the inner liner, whereby the vulcanization bonding of the inner liner to the tire body is prevented to enable a sealant chamber to be filled with a sealant to be formed to an accurate shape forming the mold releasing sheet out of a material which dissolves in the sealant enabling a decrease in the scalability of the tire caused by the mold releasing sheet remaining in the sealant chamber to be avoided. The main drawback of the invention is that the mold release sheet is a film formed of a natural polysaccharide which has a low melting point of 128.7° C., which is less than the curing temperature of tire and has low shelf life and also at high pressure of 12 to 16 kg the liquid (polysaccharide) in all probability contaminate the compounding and shall sip out before the vulcanization starts, separating inner liner, as inner liner gets vulcanized at around 180° C. with high pressure.

Therefore, there is a need to develop a process that is low cost, less time consuming and employs an accommodating element for a sealant or coolant for uniform distribution inside the tire.

### OBJECT OF THE INVENTION

The main object of the present invention is to provide a manufacturing process of a pneumatic tire accommodating an envelope sandwiched between inner liner and other part of tire to occupy a sealant.

Another object of the present invention is to provide a fluid comprising of a sealant and/or coolant and/or balancer and/or anti-freeze additives injected inside envelope integrated to the pneumatic tire.

Yet another object of the present invention is to provide a process of manufacturing a tire having one step vulcanization, in one of the process.

Still another object of the present invention is to provide a manufacturing process of tire with an envelope made of natural rubber and/or synthetic rubber and/or synthetic fibers to occupy an injected fluid that improves the strength, durability, thermal property and life of the tire.

### SUMMARY OF THE INVENTION

The present invention relates to a manufacturing process of envelope integrated pneumatic tire to improve its strength, durability and life. It provides a manufacturing process for accommodating an envelope to occupy a fluid that leads to increase the potency and verve of the tire.

In an embodiment, the present invention provides a process of manufacturing envelope integrated tire comprising steps of: placing a tread, at least one carcass ply having an inner surface and an outer surface, at least one inner liner having a inner surface and a outer surface; joining the inner surface of the carcass ply and tread of the tire; joining the outer surface of carcass ply and inner surface of inner liner along with a semi-vulcanized envelope through adhesive; wrapping a bead to connect the tire to a rim of a wheel; attaching the strengthening fabric on said wall of said tire; pasting through adhesive, curing and vulcanizing said carcass ply, inner liner and semi-vulcanized envelope on the tread to form an envelope integrated tire; injecting said sealant and/or said coolant inside said envelope through at least one valve; fixing said injection valve to avoid any kind of leakage. The inner surface of the carcass ply is pasted on the tread and the outer surface of the carcass ply is pasted on the inner surface of the inner liner. The pressure is applied by either mechanical or pneumatic. The envelope allows uniform distribution of sealant inside the tire and obviates the direct contact of air with sealant thus improving the life of sealant along with the tire.

In an embodiment, the present invention provides a process of manufacturing envelope in a tire comprising steps of, mixing of a plurality of rubber components; conducting an extrusion process on the resultant obtained to form a product; performing a size cutting process on the product obtained to produce an envelope; semi-vulcanizing said envelope ranging between 20% to 90% of curing level; obtaining a semi-vulcanized envelope. The envelope is provided with hot steam inside from inside for semi-vulcanization process and platen along with mould is not heated to keep the outer surface less vulcanized to enable better joining with inner liner and other surfaces of the tire. Once the envelope is formed, the sealant is injected through at least one valve and fixing the injection valve to avoid any kind of leakage. The envelope is made of natural rubber, and/or synthetic rubber, and/or butyl rubber, and/or bromo-butyl rubber, and/or neoprene rubber and/or EPDM with or without strengthening elements such as but not limited to synthetic fibers such as but not limited to Nylon, Rayon, Tensylon, Kevlar, Zylontec, Dyneema, high impact polystirene (HIPS) and other high strength synthetic fabric. In one of the embodiment/process said envelope is inserted at least one valve for injecting a sealant and/or a coolant and/or anti-freeze additives inside said envelope.

In yet another embodiment/process splicing and joining the ends of said envelope is done for continuity. In yet another embodiment/process splicing and joining the ends of said envelope is not done for flexibility. In one of the embodiment said envelope is made up of multi layered HIPS, nylon and/or other synthetic fiber with joining adhesive.

The above objects and advantages of the present invention will become apparent from the hereinafter set forth brief description of the drawings, detailed description of the invention, and claims appended herewith.

### BRIEF DESCRIPTION OF THE DRAWINGS

An understanding of a process of manufacturing envelope integrated tire of the present invention may be obtained by reference to the following drawing:

FIG. 1 shows a flow chart of the process of manufacturing envelope integrated tire in accordance with an embodiment of the present invention.

FIG. 2 shows a flow chart of the process of manufacturing envelope in a tire in accordance with an embodiment of the present invention.

### DETAILED DESCRIPTION OF THE INVENTION

The present invention will now be described hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention relates to a manufacturing process of envelope integrated pneumatic tire to improve its strength, durability and life. More specifically, the present invention provides a manufacturing process for accommodating an envelope to occupy a sealant that lead to increase the potency and verve of the tire.

In an embodiment, the present invention provides a process of manufacturing envelope integrated tire comprising steps of: placing a tread, at least one carcass ply having an inner surface and an outer surface, at least one inner liner having a inner surface and a outer surface; joining the inner surface of the carcass ply and tread of the tire; joining the outer surface of carcass ply and inner surface of inner liner along with a semi-vulcanized envelope through adhesive; wrapping a bead to connect the tire to a rim of a wheel; attaching the strengthening fabric on said wall of said tire; pasting through adhesive, curing and vulcanizing said carcass ply, inner liner and semi-vulcanized envelope on the tread to form an envelope integrated tire; injecting said sealant and/or said coolant inside said envelope through at least one valve; fixing said injection valve to avoid any kind of leakage. The inner surface of the carcass ply is pasted on the tread and the outer surface of the carcass ply is pasted on the inner surface of the inner liner. The pressure is applied by either mechanical or pneumatic. The envelope allows uniform distribution of sealant inside the tire and obviates the direct contact of air with sealant thus improving the life of sealant along with the tire.

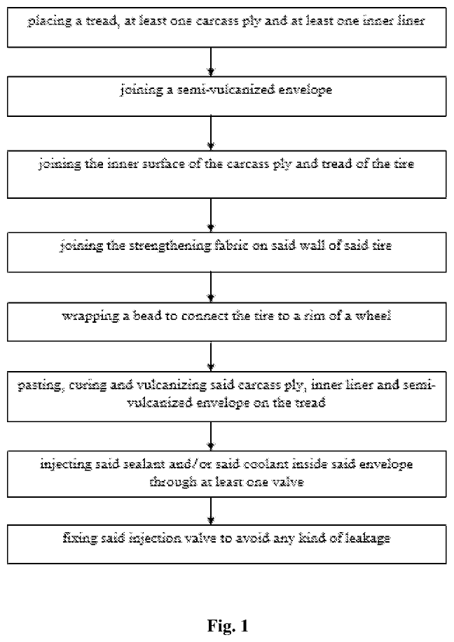

Now referring to FIG. 1, the present invention provides a flow chart of the process of manufacturing envelope integrated tire is depicted. The process of manufacturing envelope integrated tire comprising steps of:
a) placing a tread, at least one carcass ply, at least one inner liner having an inner surface and an outer surface;
b) joining a semi-vulcanized envelope between a surface of carcass ply and said inner surface of inner liner;
c) joining said surface of carcass ply and the tread of the envelope integrated tire;
d) joining a strengthening fabric on a side wall through an adhesive or multiple adhesives of said envelope integrated tire;
e) wrapping a bead to connect the envelope integrated tire to a rim of a wheel;
f) pasting through adhesive, curing and vulcanizing said carcass ply, inner liner and semi-vulcanized envelope on the tread to form an envelope integrated tire;
g) injecting a fluid inside said envelope through at least one injection valve;
h) fixing said injection valve to avoid any kind of leakage.

The fluid inside said envelope is sealant, coolant, anti-freeze additive or combination thereof. The curing takes place at a temperature ranging between 160 to 190° C. the pasting of said carcass ply, inner liner and semi-vulcanized envelope takes place at a pressure ranging between 11.7 to 16.6 bar and the duration ranging between 12 to 75 minutes depending on size and weight of said envelope integrated tire. The curing level ranges from 20% to 90%.

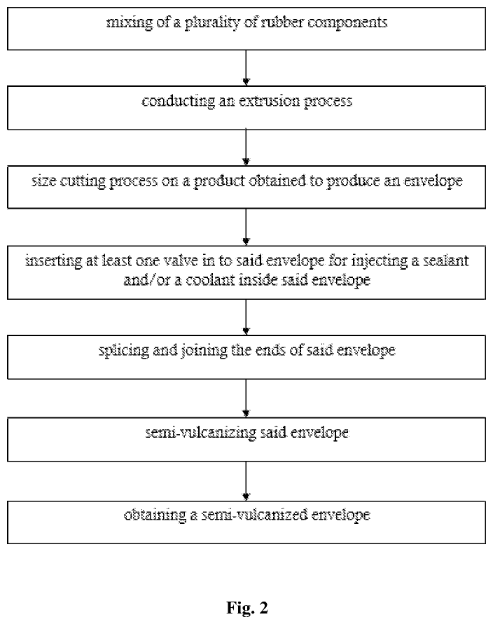

Now referring to FIG. 2, the present invention provides a flow chart of the process of manufacturing envelope in a tire is depicted. The process of manufacturing envelope in a tire.
a) mixing of a plurality of rubber components to obtain a resultant mixture;
b) conducting an extrusion process on the resultant mixture obtained in step (a) to form a product;
c) performing a size cutting process on the product obtained after step (b) to produce an envelope;
d) creating hole on said envelope for injecting a fluid or combination of fluids inside said envelope at a later stage;
e) semi-vulcanizing said envelope after step (d) by curing with hot air, steam or nitrogen from inside at desired pressure and temperature and by not heating the mould from outside by heating mould and platen, thereby obtaining limited level of curing from inside and lesser level of curing from outside making said envelope suitable for joining with other components at curing stage of said tire; and
f) obtaining a semi-vulcanized envelope at pressure ranging between 7.8 to 7.35 bar and the duration ranging between 1.2 to 3 minutes.

The carcass ply is made of materials including but not limited to natural rubber, synthetic rubber and high impact polystirene (HIPS). The pressure applied is pneumatic or mechanical. The pneumatic pressure is applied by a tube through compressed air. The mechanical pressure is applied by a clamping force by disc made for this special purpose and tightening of a clamp through screws which provide requisite force. The pressure applied is in the range of 1.7 to 3.4 bar. The variation of pressure is dependent on factors such as thickness and materials of the tire, thickness and materials of the carcass ply.

The process optionally includes step of strengthening of the envelope prior to roughening of surfaces wherein the strengthening is done by using strengthening strings or elements. Said strengthening strings or elements is selected from the group of natural/synthetic fibers such as, but not limited to Nylon, Rayon, Tensylon, Kevlar, Zylontec and other high strength synthetic fiber. Said strengthening fibers are in pieces and spread across in a random fashion or along the length or along the breadth or both or along diagonals of the carcass ply. The surfaces are joined by pasting with adhesives which include but not limited to gum and/or filler substances. Once the envelope is formed, the sealant is injected through at least one hole and the hole is joined later to avoid any leakage. The envelope is made of natural/synthetic fibers such as but not limited to Nylon, Rayon, Tensylon, Kevlar, Zylontec, high impact polystirene (HIPS) and other high strength synthetic fiber.

The material of the envelope is based on butyl rubber and reclaim butyl and/or bromo butyl rubber. In another embodiment said material of the envelope is based on butyl rubber and reclaim butyl and/or EPDM. In yet another embodiment said material of the envelope is based on butyl rubber and reclaim butyl and/or EPDM and/or neoprene rubber. In another embodiment said material of the envelope is based on natural rubber and reclaim natural rubber and/or EPDM. In another embodiment said material of the envelope is based on natural rubber and reclaim natural rubber and/or EPDM and/or neoprene rubber. In another embodiment said material of the envelope is multilayered synthetic fibers like polyamides, Nylon, Dyneema etc. The envelope is manufactured to contain sealant to seal the leakage in said tire in case of puncture and/or coolant to decrease localized over-heating.

Therefore, the manufacturing process of tire accommodates an envelope that uniformly distributes the sealant and improves the life of the tire.

There is no need of mold release sheet wrapping rather in the instant disclosure envelope is wrapped on it, which is pre-manufactured and partially cured in such a way that external curing is less and internal curing is more. So, as to keep the internal surface of envelope separated and external surface bonded with the inner liner and other parts of green tire.

In an embodiment, the present invention provides a process of manufacturing envelope in a tire comprising steps of: mixing of a plurality of rubber components; conducting an extrusion process on the resultant obtained to form a product; performing a size cutting process on the product obtained to produce an envelope; semi-vulcanizing said envelope ranging between 20% to 90% of curing level; obtaining a semi-vulcanized envelope. Said envelope is provided with hot steam inside from inside for semi-vulcanization process and platen along with mould is not heated to keep the outer surface less vulcanized to enable better joining with inner liner and other surfaces of the tire. Once the envelope is formed, the sealant is injected through at least one valve and fixing the injection valve to avoid any kind of leakage. The envelope is made of natural rubber, and/or synthetic rubber, and/or butyl rubber, and/or bromo-butyl rubber, and/or neoprene rubber and/or EPDM with or without strengthening elements such as but not limited to synthetic fibers such as but not limited to Nylon, Rayon, Tensylon, Kevlar, Zylontec, Dyneema high impact polystirene (HIPS) and other high strength synthetic fabric. In one of the embodiment/process said envelope is inserted at least one valve for injecting a sealant and/or a coolant and/or anti-freeze additives inside said envelope. In yet another embodiment/process splicing and joining the ends of said envelope is done for continuity. In yet another embodiment/process splicing and joining the ends of said envelope is not done for flexibility. In one of the embodiment said envelope is made up of multi layered HIPS, nylon and/or other synthetic fiber with joining adhesive.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A process of manufacturing envelope integrated tire comprising steps of:
a) placing a tread, at least one carcass ply, at least one inner liner having an inner surface and an outer surface;
b) joining a semi-vulcanized envelope between a surface of carcass ply and said inner surface of inner liner;
c) joining said surface of carcass ply and the tread of the envelope integrated tire;
d) joining a strengthening fabric on a side wall of said envelope integrated tire;
e) wrapping a bead to connect the envelope integrated tire to a rim of a wheel;
f) pasting through adhesive, curing and vulcanizing said carcass ply, inner liner and semi-vulcanized envelope on the tread to form an envelope integrated tire;
g) injecting a fluid inside said envelope through at least one injection valve;
h) fixing said injection valve to avoid any kind of leakage.

2. The process of manufacturing envelope integrated tire as claimed in claim 1, wherein said curing at step (f) takes place at a temperature ranging between 160 to 190° C.

3. The process of manufacturing envelope integrated tire as claimed in claim 1, wherein said joining at step (d) takes place through an adhesive or multiple adhesives.

4. The process of manufacturing envelope integrated tire as claimed in claim 1, wherein said pasting of said carcass ply, inner liner and semi-vulcanized envelope in step (f) takes place at a pressure ranging between 11.7 to 16.6 bar and the duration ranging between 12 to 75 minutes depending on size and weight of said envelope integrated tire.

5. The process of manufacturing envelope integrated tire as claimed in claim 1, wherein said envelope is made of material including but not limited to butyle rubber, bromo-butyl rubber, neoprene rubber, reclaim rubber, natural rubber, synthetic rubber and/or high impact polystyrene (HIPS), polyamides or combination of above mentioned materials.

6. A process of manufacturing envelope in a tire comprising steps of:
a) mixing of a plurality of rubber components to obtain a resultant mixture;
b) conducting an extrusion process on the resultant mixture obtained in step (a) to form a product;
c) performing a size cutting process on the product obtained after step (b) to produce an envelope;
d) creating hole on said envelope for injecting a fluid or combination of fluids inside said envelope at a later stage;
e) semi-vulcanizing said envelope after step (d) by curing with hot air, steam or nitrogen from inside at desired pressure and temperature and by not heating the mould from outside by heating mould and platen, thereby obtaining limited level of curing from inside and lesser level of curing from outside making said envelope suitable for joining with other components at curing stage of said tire; and
f) obtaining a semi-vulcanized envelope.

7. The process of manufacturing envelope as claimed in claim 6, wherein said process of manufacturing envelope includes a step of splicing and joining ends of said envelope.

8. The process of manufacturing envelope integrated tire as claimed in claim 6, wherein said hole for injecting fluid (d) takes place by fixing at least one valve in said envelope.

9. The process of manufacturing envelope integrated tire as claimed in claim 6, wherein said fluid is sealant, coolant, anti-freeze additive or combination thereof.

10. The process of manufacturing envelope as claimed in claim 6, wherein said envelop is made of rubber which includes but not limited to Nylon, Rayon, Tensylon, Kevlar, Zylontec, high impact polystyrene (HIPS) and other high strength synthetic fabric.

11. The process of manufacturing envelope as claimed in claim 6, wherein said vulcanization in step (f) takes place at pressure ranging between 7.8 to 7.35 bar and the duration ranging between 1.2 to 3 minutes.

12. The process of manufacturing envelope as claimed in claim 6, wherein said envelope is made of a material that includes but not limited to on butyl rubber and reclaim butyl and/or bromo butyl rubber.

13. The process of manufacturing envelope as claimed in claim 6, wherein said envelope is made of a material that includes butyl rubber and reclaim butyl and/or EPDM.

14. The process of manufacturing envelope as claimed in claim 6, wherein said envelope is made of a natural rubber and reclaim natural rubber and/or EPDM and/or neoprene rubber.

15. The process of manufacturing envelope as claimed in claim 6, wherein said envelope is made of a material that includes synthetic fibers like polyamides and/or Nylon and/or Dyneema and/or Kevlar and/or EPDM.

16. The process of manufacturing envelope as claimed in claim 6, wherein said curing level ranges from 20% to 90%.
